(19) United States
(12) Patent Application Publication
(10) Pub. No.: US 2017/0347138 A1
(43) Pub. Date: Nov. 30, 2017

(54) EFFICIENT TRANSCODING IN A NETWORK TRANSCODER

(71) Applicant: ARRIS Enterprises LLC, Suwanee, GA (US)

(72) Inventors: Shiv Saxena, Portland, OR (US); Peter A. Borgwardt, Portland, OR (US); Ajay Luthra, San Diego, CA (US)

(21) Appl. No.: 15/602,226

(22) Filed: May 23, 2017

Related U.S. Application Data
(60) Provisional application No. 62/340,726, filed on May 24, 2016.

(51) Int. Cl. H04N 21/2365; H04N 21/234; H04N 19/154; H04L 29/06; H04N 21/239; H04N 21/2343

(52) U.S. Cl. CPC H04N 21/23655; H04N 21/2393; H04N 21/23439; H04N 19/154; H04L 65/607; H04L 65/4084; H04N 21/23418

(57) ABSTRACT

A method is provided for improved transcoding of an encoded bit stream to be delivered in accordance with adaptive bit rate (ABR) streaming at a highest available selected bit rate using metadata. The method includes receiving a first encoded ABR stream for a given content item that is encoded at a highest available bit rate. Also received is metadata associated with encoding the given content item at a selected bit rate lower than the highest available bit rate. A second encoded ABR stream is generated for the given content item at the selected bit rate from the first encoded ABR stream and the metadata associated with encoding the given content item at the selected bit rate.

### CLAIM OF PRIORITY

This Application claims priority under 35 U.S.C. §119(e) from earlier filed U.S. Provisional Application Ser. No. 62/340,726, filed May 24, 2016, which is hereby incorporated by reference.

### BACKGROUND

An internet protocol video delivery network based on adaptive streaming techniques can provide many advantages over traditional cable delivery systems, such as greater flexibility, reliability, lower integration costs, new services, and new features. Currently available streaming media systems may rely on adaptive bit rate (ABR) coding to perform client ingest rate control. Adaptive bitrate streaming protocols, such as Hypertext Transfer Protocol (HTTP) Live Streaming (HLS), Smooth Streaming and Moving Picture Experts Group (MPEG) Dynamic Adaptive Streaming over HTTP (DASH) allow content delivery over unmanaged networks to be viewed by client devices under varying network conditions. In ABR coding, source content is encoded into alternative bit streams at different coding rates and typically stored in the same media file at the server. For example, the network providing the video presentation may include a server that reconfigures its encoder for different bit rates in order to provide the variant streams having the different bit rates. The content may be streamed in segments, fragments, or chunks at varying levels of quality corresponding to different coding rates, often switching bit streams between segments as a result of changing network condition.

If the network conditions deteriorate for an appreciable period of time, clients can access lower bandwidth representations of the content without a loss of service. In adaptive streaming, multiple bitrate representations of the content are made available on HTTP streaming servers. The client is able to ‘pull’ content from HTTP servers based on the condition of the network and the available bandwidth that the client can ingest.

### SUMMARY

Disclosed herein is a method for transcoding an encoded bit stream to be delivered in accordance with adaptive bit rate (ABR) streaming at a selected bit rate. The method includes receiving a first encoded ABR stream for a given content item that is encoded at a highest available bit rate. Also received is metadata associated with encoding the given content item at a selected bit rate lower than the highest available bit rate. A second encoded ABR stream is generated for the given content item at the selected bit rate from the first encoded ABR stream and the metadata associated with encoding the given content item at the selected bit rate.

Also disclosed herein is a transcoder that includes a decoder and an encoder. The decoder is configured to decode a first encoded ABR stream for a given content item that is encoded at a highest available bit rate. The encoder is configured to receive the first decoded ABR stream from the decoder and to receive metadata associated with encoding the given content item at a selected bit rate lower than the highest available bit rate. The encoder is also configured to generate a second encoded ABR stream for the given item at the selected bit rate from the first encoded ABR stream and the metadata associated with encoding the given content item at the selected bit rate.

Still further disclosed herein is a non-transitory computer readable storage medium storing at least one computer program that when executed encodes a content item at a highest bit rate to generate a first encoded bit stream and at one or more bit rates and/or resolutions lower than the highest bit rate to generate, for each lower bit rate and/or resolution at which the content item is encoded, pixel data and metadata associated with the pixel data. The executed computer program also stores the first encoded bit stream and metadata for each of the lower bit rates and/or resolutions at which the content item is encoded without storing the pixel data for the lower bit rates and/or resolutions at which the content item is encoded.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows a block diagram of one example of an operating environment in which the techniques described herein may be implemented.

FIG. 2 shows a content item being encoded by an encoder or a transcoder that encodes the content item at multiple bit rates.

FIG. 3 shows a transcoder requesting the content item from the storage device.

FIG. 4 shows a simplified block diagram of one example of an encoder.

FIG. 5 shows a simplified block diagram of one example of a transcoder.

FIG. 6 is a flowchart showing one example of method for streaming an ABR content item to a client device.

FIG. 7 illustrates a block diagram of one example of a computing apparatus that may be configured to implement or execute one or more of the processes required to encode and/or transcode an ABR bit stream.

### DETAILED DESCRIPTION

In one aspect, systems and techniques are described herein for more efficiently transcoding programming content. In another aspect programming content that is to be streamed in accordance with adaptive bit rate streaming techniques can be stored in a more efficient manner that reduces the amount of storage capacity that is required.

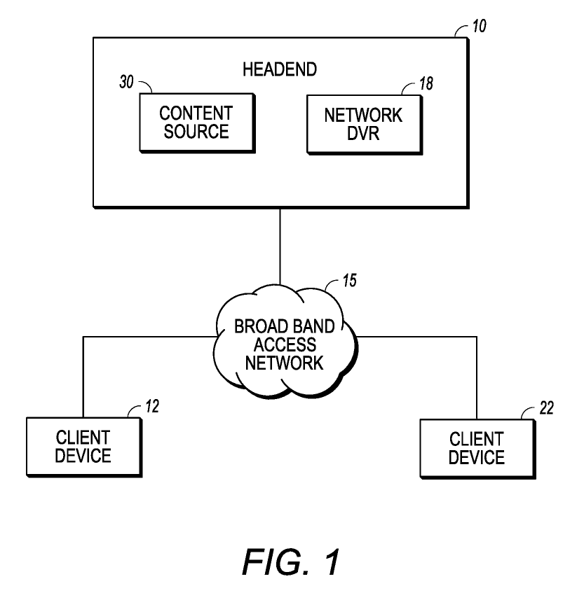

Turning to the drawings, wherein like reference numerals refer to like elements, techniques of the present disclosure are illustrated as being implemented in a suitable environment such as shown in FIG. 1. The following description is based on embodiments of the claims and should not be taken as limiting the claims with regard to alternative embodiments that are not explicitly described herein.

FIG. 1 shows a block diagram of one example of an operating environment in which the techniques described herein may be implemented. In this example a headend 10 delivers services such as programming content (e.g., video content) or the like to subscribers associated with client devices such as client devices 12 and 22. The client devices communicate with a number of network elements over one or more networks. For instance, the headend 10 in FIG. 1 is in communication with the client devices 12 and 22 over a broadband access network 15. The headend 10 is the facility from which a network operator transmits programming content and provides other services over the network. The Broadband access network 15 and headend 10 are typically provided by an MSO (Multi-Service Operator). The broadband access network 15 may be a wide area network (WAN) such the Internet or an intranet. As another example, broadband access network 15 may be a cellular network or a cable data network such as an all-coaxial or a hybrid-fiber/coax (HFC) network. Of course, other broadband access networks such as xDSL (e.g., ADSL, ADLS2, ADSL2+, VDSL, and VDSL2) and satellite systems may also be employed. In some implementations broadband access network 15 may alternatively comprise, for example, a packet-switched network that is capable of delivering IP packets directly to the set top boxes 12 and 22 using, for example, a cable data network, PON, or the like. In yet other examples the broadband access network 15 may be a combination of two or more different types of networks.

As shown in FIG. 1, headend 10 can include a network DVR 18 that stores content for subsequent transmission to a client device in response to user request. The network DVR 18 provides the subscriber with the functionality that is typically available when a subscriber employs a local DVR. The content may be provided to the network DVR from any available content source, including, for example, content source 30.

Client devices 12 and 22 may be any type of electronic devices that are capable of receiving data transmitted over a network and generating output utilizing the data received via the network. For example, client devices 12 and 22 may be digital televisions, set top boxes, wireless mobile devices, smartphones, tablets, PDAs, entertainment devices such as video game consoles, consumer electronic devices, PCs, etc. The output may be any media type or combination of media types, including, for example, audio and video.

In one embodiment, programming content may be delivered from the network DVR or other storage device in the headend 10 using a streaming media technique such as an Adaptive Bit Rate (“ABR”) streaming method. ABR streaming is a technology that works by breaking the overall media stream or media file into a sequence of small HTTP-based file downloads, each download loading one short segment of an overall potentially unbounded transport stream or media elementary streams. As the stream is played, the client device (e.g., the media player) may select from a number of different alternate streams containing the same material encoded at a variety of data rates, allowing the streaming session to adapt to the available data rate. At the start of the streaming session, the player downloads a manifest containing the metadata for the various sub-streams which are available.

HTTP Live Streaming (HLS) is one example of an ABR streaming method. HLS is an HTTP-based communications protocol suitable for media streaming of live content and is described in Internet Drafts to the Internet Engineering Task Force such as HTTP Live Streaming draft-pantos-http-live-streaming-10, Oct. 15, 2012 and all subsequent drafts. It should be noted that the techniques described herein are not limited to HLS, which is presented for purposes of illustration only. More generally, the techniques described herein are applicable to any technique that stores content that is encoded at a variety of different data rates.

In a network DVR application, each content item is stored in a server as a series of ABR streams corresponding to various bit rates and resolutions. That is, the network DVR stores multiple copies of each content item, each representing a different quality level. This typically requires a significant amount of storage capacity, which may become problematic as the number of content items being stored grows. This problem is exacerbated in those cases where a network operator is required to maintain a separate copy of a content item for each customer that records the content item on the network DVR, since this requires that the series of ABR streams be stored multiple times.

One way to address the aforementioned problem is to store for each content item only the highest bit rate stream (sometimes referred to the mezzanine layer), but only a part of the bit stream corresponding to other bit rates and/or resolutions is stored. The missing information that is not stored is to be re-generated on-the-fly by a smart transcoder in the network at the time that the customer requests to view the program at a lower bit rate. This may be accomplished using a first encoder or transcoder to encode the content item at the various bit rates and resolutions and then store in the network DVR or other server the highest bit rate stream, along with only the metadata for the lower bit rate streams. This can significantly reduce the amount of storage capacity required to store the series of bit streams for the content item.

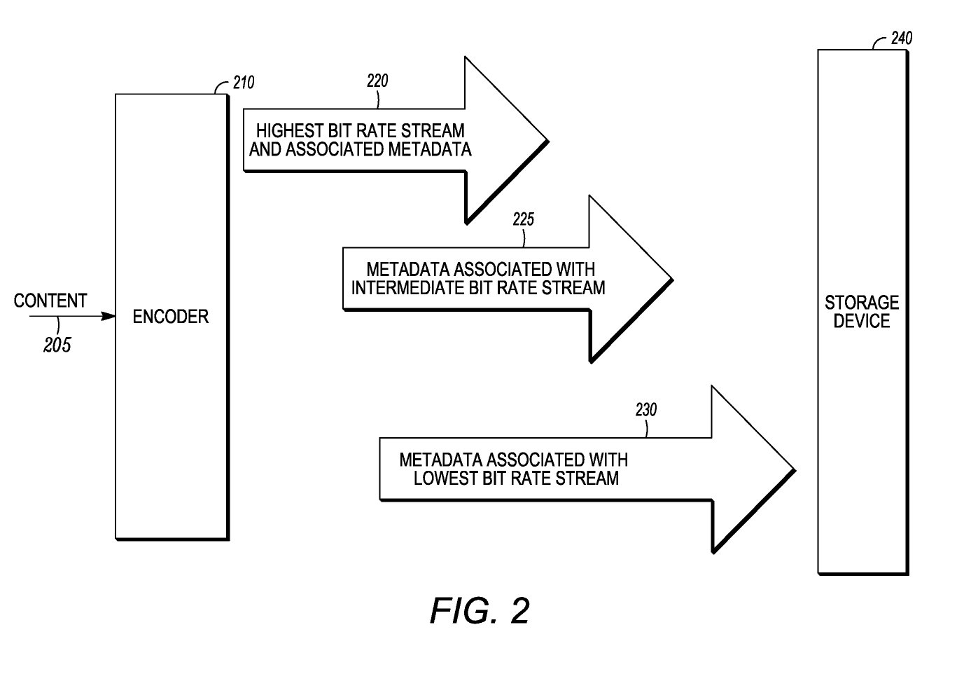

FIG. 2 shows a content item 205 being encoded by an encoder 210 (or alternatively, a transcoder) that encodes the content item 205 at multiple bit rates. For purposes of illustration the encoder 210 encodes the content item into three bit steams that include a highest, intermediate and lowest bit rate streams. Of course, more generally, the content item 205 may be encoded into any number of bit rate streams. As shown, the encoder 210 sends the highest bit rate stream and its associated metadata 220 to a storage device 240 such as network DVR. The encoder 210 also sends to the storage device 240 some or all of the metadata 225 and 230 associated with the intermediate bit rate and lowest bit rate streams, respectively. However, the encoder 210 does not store the pixel data (e.g., the DCT transform coefficients) for the intermediate and lowest bit rate streams 225 and 230 since these can be generated by a downstream transcoder as described below. In this way the storage capacity required to store all the information needed to obtain the content item at any of the various encoded bit rates is reduced

When a customer requests a content item at one of the lower bit rates, a transcoder can obtain from the storage device 240 the highest bit rate stream for the content item and the metadata for the content item corresponding to the lower bit rate stream. The transcoder can decode the highest bit rate stream, decimate it to the lower resolution requested by the customer, and then re-encode the lower bit rate stream using the information in the meta-data for the lower bit rate stream. This re-encoding can be accomplished using fewer computational resources than a full transcode would require.

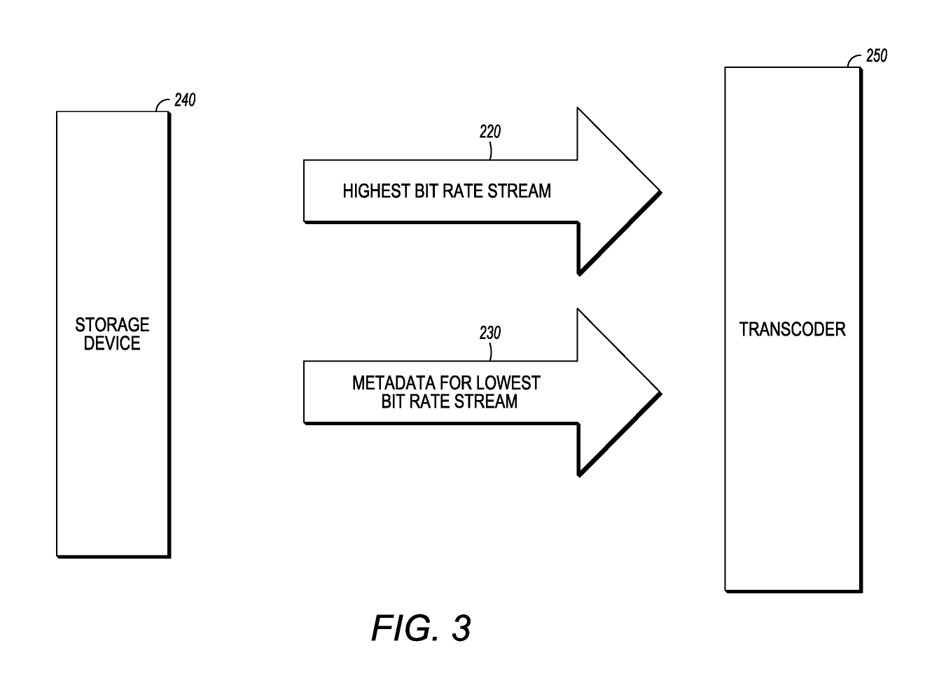

FIG. 3 shows a transcoder 250 requesting the content item 205 from the storage device 240. In this example the transcoder is responding to a request for the lowest bit rate stream. Accordingly, the transcoder 250 obtains from the storage device 240 the highest bit rate stream 220 for the requested content item and the metadata 230 associated with the encoded lowest bit rate stream. The transcoder 250 processes the highest bit rate stream 220 and the metadata 230 to output an encoded lowest bit rate stream for the requested content item.

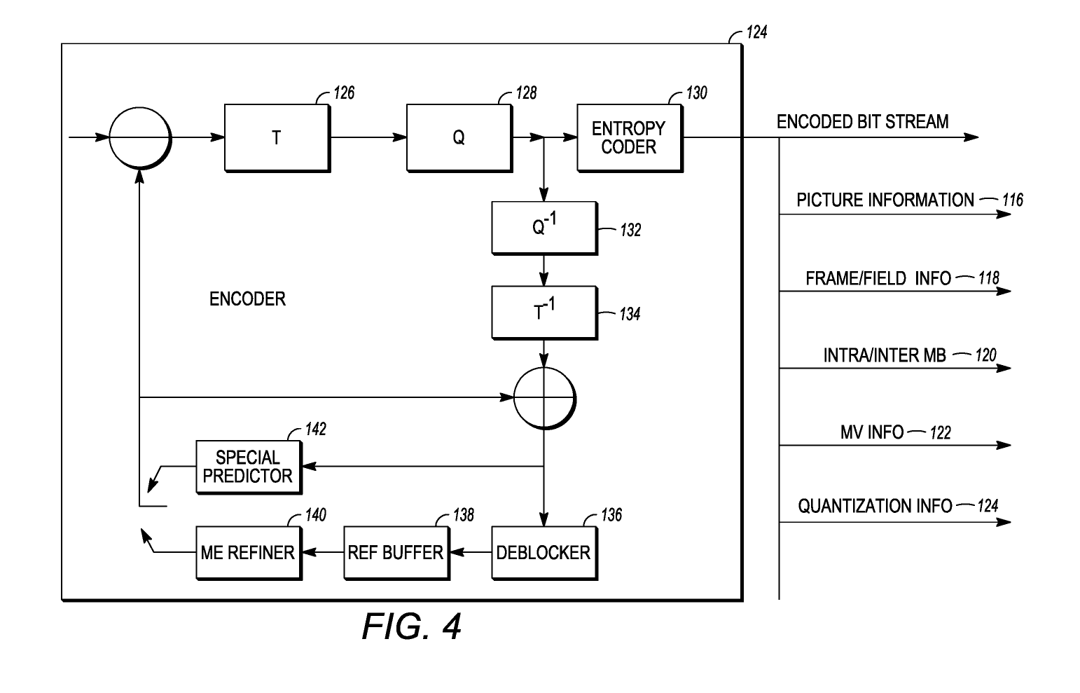

FIG. 4 shows a simplified block diagram of one example of an encoder 124 that may encode the content item in the manner described and as illustrated in FIG. 2. Encoder 124 may conform to any of a variety of standards such as the H.264, MPEG and HEVC standards. In the case of the illustrative operating environment shown in FIG. 1, the encoder may be located in the headend 10 and receive the content items from the content source 30 (which may provide either recorded or live content) and store the encoded content in the network DVR 18. Of course, the encoder need not be co-located with the headend 10 and/or the network DVR 18 in other operating environments, some which need not even store the content in a network DVR. That is, the techniques and systems described herein are not limited to network DVR applications.

The encoder 124 includes a transform module 126 (e.g., a discrete cosine transform (DCT) based module) to apply a transform to generate transform coefficients such as DCT coefficients, a quantizer 128 for quantizing the transform coefficients, an entropy coder 130 for removing statistical redundancies in the data, an inverse quantizer 132, an inverse transform module 134, a deblocker 136, a reference buffer 138, a motion estimation (ME) refiner 140, and a temporal or spatial prediction module 142 for performing spatial prediction and for estimating motion vectors for temporal prediction.

In one embodiment, the temporal or spatial prediction module 142 comprises a variable block motion estimation module and a motion compensation module. The motion vectors from the variable block motion estimation module are received by the motion compensation module for improving the efficiency of the prediction of sample values. Motion compensation involves a prediction that uses motion vectors to provide offsets into the past and/or future reference frames containing previously decoded sample values that are used to form the prediction error. Namely, the temporal or spatial prediction module 142 uses the previously decoded frame and the motion vectors to construct an estimate of the current frame.

The components 126-142 may comprise software modules, hardware modules, a combination of software and hardware modules, or an application specific integrated circuit (ASIC). Thus, in one embodiment, one or more of the modules 126-142 comprise circuit components. In another embodiment, one or more of the modules 126-142 comprise software code stored on a computer readable storage medium, which is executable by a processor. In another embodiment, the modules 126-142 comprise an ASIC.

It will be apparent that the encoder 124 may include additional elements not shown and that some of the elements described herein may be removed, substituted and/or modified without departing from the scope of the encoder 124. It should also be apparent that one or more of the elements described in the example of FIG. 4 may be optional.

The output from the encoder 124 includes an encoded bit stream that includes pixel data (e.g., transform coefficients such as the DCT transform coefficients) and metadata. The metadata may include, by way of illustration, picture information 116, frame/field information 118, intra/inter information 120, motion vector (MV) information 122 indicating at least one MV in inter mode and quantization information 124 indicating the various quantization parameters that are used in the encoding process, including information about the quantization method that has been used.

The picture information 116, the frame/field information 118, the intra/inter information 120, the MV information 122 and the quantization information 124 comprise metadata that indicates how the information was encoded in the encoded bit stream and may be used to determine how to re-encode the decoded information in a downstream transcoder. The picture information 116 comprises metadata at a picture level and may include a picture type, and a picture level frame/field mode. The picture type indicates whether the picture is an I picture, a P picture, or a B picture. The frame/field information 118 comprises metadata at the picture level and indicates whether a macroblock (MB) is encoded in one of a frame mode or a field mode. The metadata therefore indicates whether the picture is a frame picture or a field picture. The intra/inter information 120 comprises metadata at a MB level and indicates whether the MB is encoded in one of an intra mode or an inter mode at the MB level.

As discussed above, encoder 124 may be used to encode content items as ABR streams at different bit rates. A downstream transcoder subsequently may generate any selected one of the lower bit rates streams for a given content item by receiving (either from the encoder 124, a storage device in which the data from the encoder is stored, or elsewhere) the highest bit rate stream for the given item along with the metadata associated with the selected lower bit rate stream for the given content item.

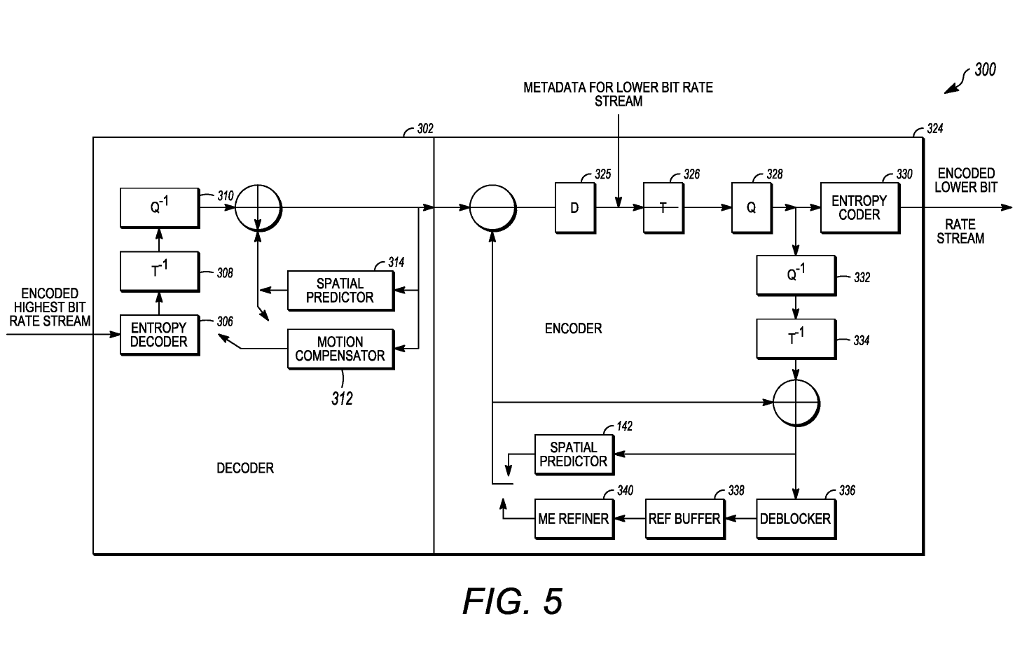

A simplified block diagram of one example of a suitable transcoder that may be employed is shown in FIG. 5. The transcoder 300 includes a decoder 302 and an encoder 324. For purposes of illustration encoder 324 is similar to encoder 124 shown in FIG. 4, though of course this need not be the case. The decoder 302 is used to decode the encoded bit rate stream for the highest bit rate stream of a given content item (e.g., bit stream 220 shown in FIG. 3). The decoded highest bit rate stream is then provided to the encoder 324 by the decoder 102, which is also provided with the metadata associated with the desired encoded lower bit rate stream for the given content item.

The processing involved in decoding performed by decoder 302 is largely the inverse processes of the corresponding methods used by the encoder 124 shown in FIG. 4. Decoder 302 includes an entropy decoder 306, an inverse transformer 308, an inverse quantizer 310, a motion compensator 312, and a spatial predictor 314.

As shown in FIG. 5, the decoded bit rate stream output from the decoder 302 is provided to the input of the encoder 324. The decoded bit stream is first directed a decimator 325, which decimates the content item to the desired resolution. This reduced bit rate stream, along with the metadata associated with the desired encoded lower bit rate stream for the given content item, is then re-encoded at the reduced bit rate using transform module 326 (e.g., a discrete cosine transform (DCT) based module) to apply a transform to generate transform coefficients such as DCT coefficients, a quantizer 328 for quantizing the transform coefficients, an entropy coder 330 for removing statistical redundancies in the data, an inverse quantizer 332, an inverse transform module 334, a deblocker 336, a reference buffer 338, a motion estimation (ME) refiner 340, and a temporal or spatial prediction module 342 for performing spatial prediction and for estimating motion vectors for temporal prediction.

The components or modules 306-314 and 325-342 may comprise software modules, hardware modules, a combination of software and hardware modules, or an application specific integrated circuit (ASIC). Thus, in one embodiment, one or more of the modules 306-314 and 325-342 comprise circuit components. In another embodiment, one or more of the modules 306-314 and 325-342 comprise software code stored on a computer readable storage medium, which is executable by a processor. In another embodiment, the modules 306-314 and 325-342 comprise an ASIC.

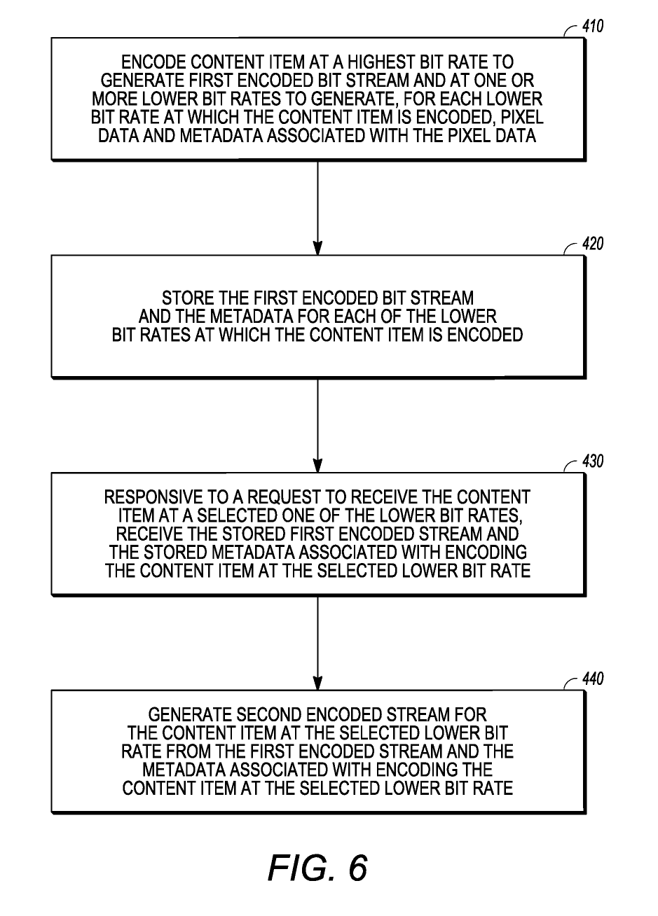

FIG. 6 is a flowchart showing one example of a method for streaming an ABR content item to client device. The method begins at block 410 when a content item is encoded at a highest bit rate to generate a first encoded bit stream. The content item is also encoded at one or more bit rates lower than the highest bit rate to generate, for each lower bit rate at which the content item is encoded, pixel data and metadata associated with the pixel data. At block 420 the first encoded bit stream and the metadata for each of the lower bit rates at which the content item is encoded is stored in a storage device without also storing the pixel data for the lower bit rates at which the content item has been encoded. Responsive to a request to receive the content item at a selected one of the lower bit rates, the first encoded stream for the content item that is encoded at the highest available bit rate is received from the storage device at block 430. At block 430 the stored metadata associated with encoding the content item at the selected lower bit rate is also received. At block 440 a second encoded stream for the content item is generated at the selected lower bit rate from the first encoded stream and the metadata associated with encoding the content item at the selected lower bit rate.

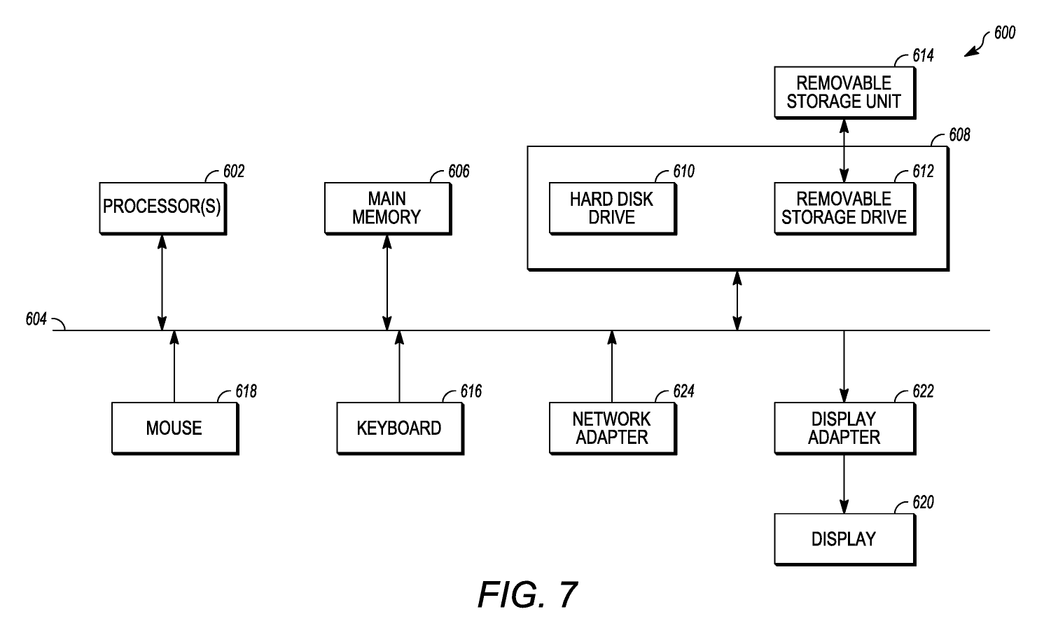

FIG. 7 illustrates a block diagram of one example of a computing apparatus 600 that may be configured to implement or execute one or more of the processes required to encode and/or transcode an ABR bit stream using the techniques described herein. It should be understood that the illustration of the computing apparatus 600 is a generalized illustration and that the computing apparatus 600 may include additional components and that some of the components described may be removed and/or modified without departing from a scope of the computing apparatus 600.

The computing apparatus 600 includes a processor 602 that may implement or execute some or all of the steps described in the methods described herein. Commands and data from the processor 602 are communicated over a communication bus 604. The computing apparatus 600 also includes a main memory 606, such as a random access memory (RAM), where the program code for the processor 602, may be executed during runtime, and a secondary memory 608. The secondary memory 608 includes, for example, one or more hard disk drives 410 and/or a removable storage drive 612, where a copy of the program code for one or more of the processes depicted in FIGS. 2-5 may be stored. The removable storage drive 612 reads from and/or writes to a removable storage unit 614 in a well-known manner.

As disclosed herein, the term “memory,” “memory unit,” “storage drive or unit” or the like may represent one or more devices for storing data, including read-only memory (ROM), random access memory (RAM), magnetic RAM, core memory, magnetic disk storage mediums, optical storage mediums, flash memory devices, or other computer-readable storage media for storing information. The term “computer-readable storage medium” includes, but is not limited to, portable or fixed storage devices, optical storage devices, a SIM card, other smart cards, and various other mediums capable of storing, containing, or carrying instructions or data. However, computer readable storage media do not include transitory forms of storage such as propagating signals, for example.

User input and output devices may include a keyboard 616, a mouse 618, and a display 620. A display adaptor 622 may interface with the communication bus 604 and the display 620 and may receive display data from the processor 602 and convert the display data into display commands for the display 620. In addition, the processor(s) 602 may communicate over a network, for instance, the Internet, LAN, etc., through a network adaptor 624.

Embodiments of the invention provide methods and systems for transcoding encoded content in a more efficient manner that requires fewer computational resources. Moreover, the methods and systems described herein allow programming or other content that is to be streamed in accordance with adaptive bit rate streaming techniques to be stored in a more efficient manner.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the embodiments of the invention.

1. A method for transcoding an encoded bit stream to be delivered in accordance with adaptive bit rate (ABR) streaming at a selected bit rate, comprising:
receiving a first encoded ABR stream for a given content item that is encoded at a highest available bit rate;
receiving metadata associated with encoding the given content item at a selected bit rate lower than the highest available bit rate; and
generating a second encoded ABR stream for the given content item at the selected bit rate from the first encoded ABR stream and the metadata associated with encoding the given content item at the selected bit rate.

2. The method of claim 1, wherein generating the second encoded ABR stream includes decoding the first encoded ABR stream and decimating the first decoded ABR stream to the selected bit rate.

3. The method of claim 2, further comprising re-encoding the decoded ABR stream after decimating using the metadata.

4. The method of claim 1, wherein the metadata includes at least one item selected from the group including picture information, frame/field information, and intra/inter information, motion vector (MV) information and quantization information.

5. The method of claim 1, wherein the metadata includes picture information, frame/field information, and intra/inter information, motion vector (MV) information and quantization information.

6. The method of claim 1, wherein receiving the first encoded ABR stream and the metadata includes receiving the first encoded ABR stream and the metadata from a storage device that stores a plurality of content items, the storage device storing, for each of the content items being stored, an encoded ABR bit stream at a highest available bit rate and metadata associated with encoding each respective one of the content items at one or more bit rates lower than the highest available bit rate but not pixel data generated by encoding each respective one of the content items at the one or more lower bit rates.

7. The method of claim 6, wherein the storage device is network DVR.

8. The method of claim 4, wherein the metadata further includes information indicating a method of quantization used when the metadata is generated by encoding the given content item at the selected bit rate.

9. The method of claim 4, wherein the metadata further includes information concerning a decimation filter used when the first encoded ABR stream is encoded at the highest available bit rate.

10. The method of claim 6, wherein the pixel data include discrete cosine transform (DCT) coefficients generated by encoding each respective one of the content items at the one or more lower bit rates.

11. A transcoder, comprising:
a decoder configured to:
decode a first encoded ABR stream for a given content item that is encoded at a highest available bit rate;
an encoder configured to:
receive the first decoded ABR stream;
receive metadata associated with encoding the given content item at a selected bit rate lower than the highest available bit rate; and
generate a second encoded ABR stream for the given item at the selected bit rate from the first encoded ABR stream and the metadata associated with encoding the given content item at the selected bit rate.

12. The transcoder of claim 11, wherein the encoder is further configured to decimate the first decoded ABR stream to a selected picture resolution.

13. The transcoder of claim 12, wherein the encoder is further configured to re-encode the decoded ABR stream after decimating using the metadata.

14. A non-transitory computer readable storage medium storing at least one computer program that when executed performs a method comprising:
encoding a content item at a highest bit rate to generate a first encoded bit stream and at one or more bit rates and/or resolutions lower than the highest bit rate to generate, for each lower bit rate and/or resolution at which the content item is encoded, pixel data and metadata associated with the pixel data; and
storing the first encoded bit stream and metadata for each of the lower bit rates and/or resolutions at which the content item is encoded without storing the pixel data for the lower bit rates and/or resolutions at which the content item is encoded.

15. The one or more non-transitory computer readable storage media of claim 14, further comprising:
responsive to a request to receive the content item at a selected one of the lower bit rates and/or resolutions, receiving the stored first encoded stream for the content item that is encoded at the highest available bit rate;
receiving the stored metadata associated with encoding the content item at the selected lower bit rate and/or resolution; and
generating a second encoded stream for the content item at the selected lower bit rate and/or resolution from the first encoded stream and the metadata associated with encoding the content item at the selected lower bit rate.

16. The one or more non-transitory computer readable storage media of claim 15, wherein generating the second encoded stream includes decoding the first encoded stream and decimating the first decoded stream to a selected resolution.

17. The one or more non-transitory computer readable storage media of claim 14, further comprising re-encoding the first decoded stream after decimating using the metadata.

18. The one or more non-transitory computer readable storage media of claim 14, wherein the metadata includes at least one item selected from the group including picture information, frame/field information, and intra/inter information, motion vector (MV) information and quantization information.

19. The one or more non-transitory computer readable storage media of claim 14, wherein the metadata includes picture information, frame/field information, and intra/inter information, motion vector (MV) information and quantization information.

20. The one or more non-transitory computer readable storage media of claim 14, further comprising streaming the second encoded stream to a client device in accordance with an ABR streaming technique.
